(19) United States
(12) Patent Application Publication
(10) Pub. No.: US 2022/0094241 A1
(43) Pub. Date: Mar. 24, 2022

(54) HYBRID HYDROELECTRIC TIDAL POWER ELECTRICITY GENERATOR AND METHOD

(71) Applicant: Ayman Shata, Des Plaines, IL (US)

(72) Inventor: Ayman Shata, Des Plaines, IL (US)

(21) Appl. No.: 17/245,796

(22) Filed: Apr. 30, 2021

Related U.S. Application Data
(60) Provisional application No. 63/081,610, filed on Sep. 22, 2020.

(51) Int. Cl. H02K 7/18; F03B 13/10; F03B 17/06

(52) U.S. Cl. CPC H02K 7/1823; F03B 13/10; F05B 2220/706; F05B 2220/32; F03B 17/06

(57) ABSTRACT

A hybrid hydroelectric tidal power electricity generator is provided for generation of electrical power using a hybrid system to promote increased efficiency. The hybrid hydroelectric tidal power electricity generator may include a turbine, thruster, thrust pathway, reservoirs and channels. A method for generation of electrical power using a hybrid system to promote increased efficiency using the hybrid hydroelectric tidal power electricity generator is also provided.

### CROSS-REFERENCE TO RELATED APPLICATION

This application claims the priority from U.S. provisional patent application Ser. No. 63/081,610 filed Sep. 22, 2020. The foregoing application is incorporated in its entirety herein by reference.

### FIELD OF THE INVENTION

The present disclosure relates to a hybrid hydroelectric tidal power electricity generator. More particularly, the disclosure relates to generation of electrical power using a hybrid system to promote increased efficiency.

Hydroelectrical power is a form of energy that harnesses the power of water in motion. More specifically, hydroelectrical systems may utilize tidal energy which is configured to convert energy from the tides particularly in large bodies of water. For a hydroelectrical system to perform the aforementioned, water turbines are installed underwater to harvest tidal power resulting in the tidal power being converted into mechanical energy. However, there are multiple drawbacks to current hydroelectrical systems. For example, installation and maintenance of the water turbines along with the high respective costs render the systems difficult to implement on a large scale. Furthermore, integrating these systems can pose a significant risk to the marine ecosystem and overall marine life preservation.

Moreover, in some configurations, hydroelectrical systems require one or more dams which results in reservoirs and placement of said dams being considerably limited in where they may be located. Thus, implementation of hydroelectrical systems can sometimes require relocation of both terrestrial and aquatic communities adding to the economical toll associated with integrating such complex systems. However, one of the largest drawbacks of current hydroelectrical systems is the inability to control the flow of forces necessary to power the underwater turbines, especially in open water settings having great depth.

Therefore, a need exists to solve the deficiencies present in the prior art. What is needed is an efficient hydroelectrical tidal power system.

### SUMMARY

An aspect of the disclosure advantageously provides an efficient hydroelectrical tidal power system.

According to an embodiment of this disclosure, a hydroelectrical power generation system is provided that may include a thruster, a thrust pathway, a generator, and/or other components. The thruster may be configured to receive power from an external power source. For example, the thruster may receive a fluid at a first flow rate from a first fluid source. The thruster may increase the first flow rate to a second flow rate. The thrust pathway may increase the second flow rate to a third flow rate. The turbine may receive the fluid from the thrust pathway. The generator may be driven by the turbine.

In another aspect, the first fluid source may be one of a naturally flowing water source and a man-made flowing water source.

In another aspect, the thruster may include a plurality of blades.

In another aspect, a plurality of thrusters may be included upstream, in terms of fluid flow, of the thrust pathway.

In another aspect, the thrust pathway may include a fluid inlet area that is larger than a fluid outlet area.

In another aspect, the thrust pathway may be at least partially conical.

In another aspect, the generator may be configured to connect to a power storage/grid.

According to an embodiment enabled by this disclosure, a hydroelectrical power generation system may be provided including a first fluid source, a second fluid source, a transition interface, and a thrust pathway. The second fluid source may be located in a closed loop communication with the first fluid source. The transition interface may be located between the first fluid source and the second fluid source. The transition interface may prevent fluid flow from the second fluid source to the first fluid source until a fluid threshold is reached. A thrust pathway may be provided to receive fluid at one flow rate from the first fluid source and may increase the one flow rate to another flow rate. A turbine may be provided to receive the fluid from the thrust pathway and discharges the fluid to the second fluid source. A generator may be driven by the turbine.

In another aspect, the first and second fluid sources may be contained within a single reservoir.

In another aspect, the transition interface may include an inclined surface.

In another aspect, the transition interface includes an upstanding wall that acts as the fluid threshold.

In another aspect, a thruster may be provided upstream, in terms of fluid flow, the thrust pathway, wherein the thruster increases the one flow rate to a further flow rate.

In another aspect, a thruster may be provided downstream, in terms of fluid flow, the first fluid source, wherein the thruster increases the one flow rate to a further flow rate.

In another aspect, the thrust pathway may include a fluid inlet aperture and a fluid outlet aperture that is smaller than the fluid inlet aperture.

According to an embodiment enabled by this disclosure, a method of generating hydroelectric power is provided, which may include the steps of receiving a flow of fluid from one of an open fluid source and a closed fluid source; increasing a first flow rate of the fluid from the open fluid source to a second flow rate by using one component powered by an external power source; increasing the second flow rate to a third flow rate by using another component that operates without the external power source; and using the fluid at the third flow rate to operate a generator.

In another aspect, the method may include the step of using the fluid at the third flow rate to operate a turbine that is tied to the generator.

In another aspect, one component may be a thruster having blades.

In another aspect, one component may be a set of thrusters each having blades.

In another aspect, another component may be a conical shaped thrust pathway.

In another aspect, the method may include the step of connecting the generator to a power storage/grid.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIGS. 1A-1B illustrate an exemplary hydroelectrical power system, and components thereof, according to an exemplary embodiment of this disclosure.

FIGS. 2A-2E illustrate another exemplary hydroelectrical power system, and components thereof, according to another exemplary embodiment of this disclosure.

FIGS. 3A-3B are plan views of exemplary sets of thrusters, which may be implemented in the above systems, according to an exemplary embodiment of this disclosure.

FIG. 4 illustrates a computer system, according to an exemplary embodiment of this disclosure.

### DETAILED DESCRIPTION

The following disclosure is provided to describe various embodiments of a hybrid hydroelectric tidal power electricity generator. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more elements in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term “turbine”, as it is used throughout this disclosure, is defined as a rotary mechanical device that extracts energy from a fluid flow and converts it into useful work. The term “thruster”, as it is used throughout this disclosure, is defined as a propulsive device. The term “thrust pathway”, as it is used throughout this disclosure, is defined as a path along which fluid forces flow. The term “hydroelectric power generation”, as it is used throughout this disclosure, is defined as electricity produced from hydropower. The term “tidal power generation”, as it is used throughout this disclosure, is defined as power produced by converting energy from tides.

Additionally, references to “water” throughout this disclosure is intended to be interpreted broadly to include other fluids without limitation, unless expressly stated otherwise.

Various aspects of the present disclosure will now be described in detail, without limitation. In the following disclosure, a hybrid hydroelectric tidal power electricity generator will be discussed. Those of skill in the art will appreciate alternative labeling of the hybrid hydroelectric tidal power electricity generator as a hydroelectrical power generation system, the invention, or other similar names. Similarly, those of skill in the art will appreciate alternative labeling of the hybrid hydroelectric tidal power electricity generator as a hydroelectrical tidal power generation system, method, operation, the invention, or other similar names. Skilled readers should not view the inclusion of any alternative labels as limiting in any way.

This disclosure provides illustrative embodiments that improve upon the problems with the prior art by describing a hybrid hydroelectrical system and method associated with said system configured to utilize components such as generators and tidal power in an eco-friendly and economically sustainable manner that supports flexible installation, easy maintenance, reduction of CO₂ footprint, and promotes preservation of marine life and marine ecosystems. In particular, the disclosure provides illustrative embodiments describing a combination of power sources, turbines, thrusters, and communicative couplings of the aforementioned components to assist with controlling quantities and flows of water and/or other fluids in hydroelectrical systems, without limitation.

In one or more embodiments, a hydroelectrical power system is disclosed. The system may comprise a power source, a turbine configured to drive the power source, a thruster configured to direct water to the turbine, and a thrust pathway associated with the thruster configured to increase the velocity of water and/or another fluid used by a system enabled by this disclosure.

In one or more embodiments, a hydroelectrical power system is disclosed, without limitation. The system may include a primary power source, a turbine that may include a turbine aperture, a thruster that may include a thruster pathway wherein the thruster pathway may include at least a partially conical shape, a secondary power source, a first reservoir, a second reservoir, and a reservoir transition interface that may be configured to facilitate the flow of water between the first and second reservoirs via assistance from the thruster.

The systems and methods enabled by this disclosure may allow mechanically generated water current provided by novel water thrusters to establish fluid flow to generate enough force to turn underwater turbine blades, resulting in electricity being generated to power grids, electricity being stored in a power storage component, and/or otherwise being used in a manner that will be appreciated by a person of skill in the art. The present disclosure facilitates a cycle of water flow powered by speed controlling thrusters and thruster pathways, for example being conical in shape, supported by one or more reservoirs ensuring that water/fluid may be approximately continuously directed into the path of the turbine(s). In one embodiment, the water and/or other fluid may be cycled throughout the system accordingly.

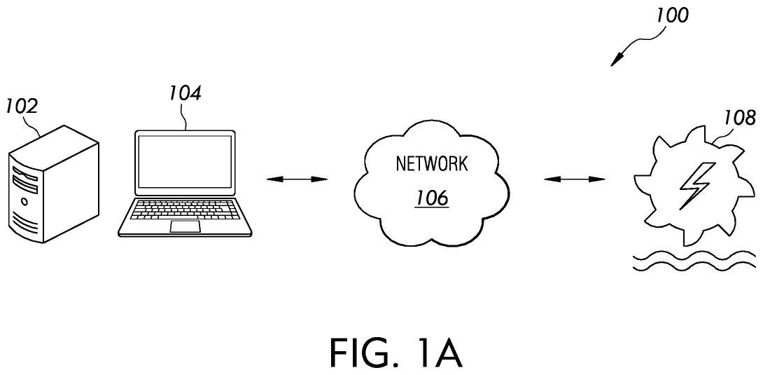

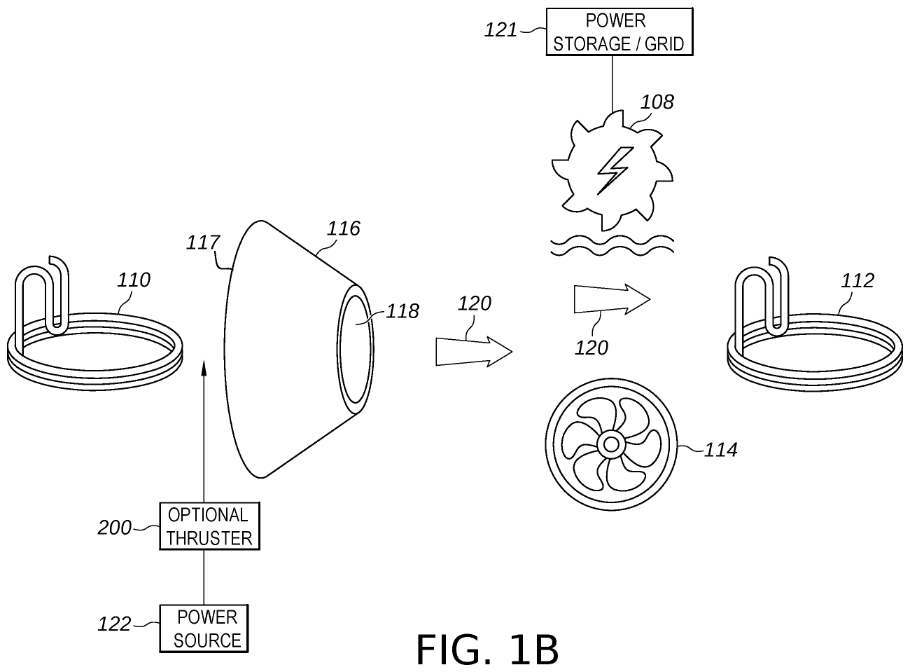

Referring now to FIG. 1A, an exemplary hydroelectrical system 100 may function as a tidal power station configured to utilize the rise and fall of ocean water due to tides allowing the water to flow between reservoirs. In embodiments, the hydroelectrical system 100 and/or associated power station may advantageously be deployed to function as a dispatchable electrical power source at the request of one or more associated power grids.

According to embodiments, the system 100 may include a server 102, a computing device and/or terminal 104, a communications network 106, and a hydroelectric generator 108. These embodiments may additionally be referred to as a primary power source, wherein each of the aforementioned components may be communicatively connected via network 106.

In various embodiments, the hydroelectrical system 100 may further include one or more sensors (not shown) allocated on-site, for example, at the location of the hydroelectrical system 100. The sensors may be configured to collect data in real-time associated with conditions necessary to efficiently operate components of the system 100 described throughout this disclosure. For example, conditions collected by the one or more sensors may include, without limitation, water level, pressure, temperature, humidity, barometric conditions, weather history, water flow, chemical balance, pH levels, oxygen reduction potential (ORP), calcium levels, salinity levels, tidal data, and/or any other applicable condition configured for operating water powered systems.

As described throughout this disclosure, the computing device 104 may be and/or include a mobile phone, tablet, smart phone, desktop, laptop, wearable technology (smartwatch), or any other applicable device or system comprising at least a processor. Those of skill in the art will appreciate that the above list of computing devices is not intended to be limited. Skilled artisans will appreciate additional examples of computing devices to be included by this disclosure, after having the benefit of this disclosure.

In embodiments, the hydroelectrical system 100 may include a turbine, thruster, thrust pathway, reservoirs, channels, and additional components that will be discussed in greater detail below. The hydroelectrical system 100 may operate one or more of these components interactively with other components for generation of electrical power using a hybrid system to promote increased efficiency.

Referring to FIG. 1B, in open and/or closed fluid embodiments, the system 100 may include a first reservoir 110, a second reservoir 112, at least one turbine 114 configured to drive a hydroelectric generator 108, and one or more thrust pathways 116 associated with one or more thrusters (described in greater detail below). In at least one example, the thrust pathway may have a conical shaped portal, also known as a thrust pathway aperture 118, to allow a flow of accelerated water 120 and/or other fluid to define the water path associated with a turbine 114 and the direction of water flow for the overall system 100.

The reservoirs will now be discussed in greater detail. FIG. 1B highlights an example of the reservoirs, which may also be shown in other figures.

In certain embodiments, reservoirs 110, 112 may be a first fluid source and a second fluid source. The first and/or second fluid sources may be an open fluid source (e.g., open water), a closed fluid source (e.g., closed water such as tanks), a combination thereof, and/or any other applicable body of water configuration in a contained or uncontained environment. In a contained environment, the first and second fluid sources may be in a closed loop path/communication configuration wherein fluid circulates from the first fluid source to the second fluid sources, and back to the first fluid source. In an open environment, the first and second fluid sources may be in an open loop path/communication configuration wherein fluid circulates from the first fluid source to the second fluid sources, but not back to the first fluid source.

In open water embodiments, the first fluid source may be a naturally flowing water source, such as an ocean, a river, a stream, or a bay. In other open water embodiments, the first fluid source may be a man-made flowing water source, such as a dam. In embodiments, open water sources may be separate from but still communicate with reservoirs 110, 112.

In closed water embodiments, the first and second fluid sources may be contained in a single tank/reservoir, or in multiple tanks/reservoirs.

In either open water or closed water embodiments, at least one of the reservoirs (i.e., first and second fluid sources) 110, 112 may include one or more stability walls configured to be structurally capable of resisting the pressure applied by the applicable internal and external body of water associated with the hydroelectrical system 100.

In embodiments, the reservoirs (i.e., first and second fluid sources) 110, 112 may be designed and allocated respective to the size of a turbine 114 to accommodate the volume of fluid needed to rotate the turbine at a desired rate. For example, and without limitation, a desired rate at which the turbine may rotate may include a rate with high or optimal operational efficiency.

Accordingly, in embodiments, the first reservoir 110 (either as or separate from the first fluid source) may discharge fluid at a first flow rate towards the turbine 114, whereby the turbine 114 can discharge fluid at another flow rate higher than the first flow rate. In one embodiment, provided without limitation, a relational formula may be applied such as V1*A1=V2*A2. In some embodiments, the output flow rate may be based on a relationship between an input diameter and an output diameter, as will be appreciated by those of skill in the art. As examples, a ratio of the first flow rate to the turbine discharge flow rate may be from about 2 meters per second (m/s) to about 6 m/s, or from about 2 m/s to about 8 m/s, or from about 4 m/s to about 10 m/s.

The turbine will now be discussed in greater detail. FIG. 1B highlights an example of the turbine, which may also be shown in other figures.

In embodiments, the turbine 114 may be directly or indirectly upstream, in terms of fluid flow, of the second reservoir 112. The turbine 114 may also be directly or indirectly downstream, in terms of fluid flow, of the thrust pathway(s) described below. Thus, the turbine 114 can operate by using the fluid flow without the need for an external power source.

In embodiments, the turbine 114 may comprise one or more impellers composed of bronze, stainless steel, cast iron, aluminum, polycarbonate, composites, plastics, carbon fiber, and/or any other applicable material configured to sustain functionality for rotating parts of a centrifugal pump, compressor, and/or other machinery designed to move a fluid by rotation.

The impellers may include an open configuration, a closed configuration, and/or a semi-enclosed configuration. In embodiments, the configuration of the impellers may permit being controlled automatically or at least partially automatically by the computerized server 102 based on at least a subset of data collected by the sensors or via a user operating on a user interface associated with the system 100, such as may be provided via the computing device 104. For example, the server 102 may transition the impellers from an open configuration to a closed configuration or semi-closed configuration determined at least partially by analyzing information received by one or more sensors. An example of data that may be detected by a sensor may include, without limitation, a threshold fluid pressure. The server 102 may analyze the data and prompt the user and suggest the user to change the configuration of the one or more impellers to adjust the components of the system 100 to increase the efficacy of the system.

In embodiments, the turbine 114 can receive fluid from the thrust pathway(s) further described below. The turbine 114 may further include a turbine aperture configured to assist with the efficiency and overall functionality associated with the turbine 114. In one example, the turbine aperture may be smaller than a thrust pathway aperture described below. In one or more examples, the turbine aperture may advantageously prevent drag of the accelerated water that may otherwise potentially disrupt the water flow and reduce efficiency of the turbine 114 and increase the operating temperature of the surrounding environment.

According to embodiment, the turbine 114 can increase a fluid flow rate entering the turbine 114 to a fluid flow rate exiting the turbine 114 by a ratio of from about 2 m/s to about 6 m/s, or from about 2 m/s to about 8 m/s, or from about 4 m/s to about 10 m/s, without limitation.

The thrust pathway will now be discussed in greater detail. FIG. 1B highlights an example of the thrust pathway, which may also be shown in other figures.

In embodiments, one or more thrust pathways 116 may be shaped and sized to serve as an entrance for the flow of accelerated water 120 to enter from and return to at least one of the reservoirs 110, 112. In embodiments, the thrust pathway may be shaped and sized to accelerate the flow of fluid from one of the reservoirs 110, 112 and into the turbine 114. Accordingly, in embodiments, the thrust pathway may be at least partially conical in shape.

According to various embodiments, one or more thrust pathways 116 may include a fluid inlet area/aperture 117 and a fluid outlet area/aperture 118 (i.e., thrust pathway aperture). In embodiments, the fluid inlet area 117 is larger than the fluid outlet area 118. In certain embodiments, a ratio of fluid inlet area to fluid outlet area is from about 3 meters² to about 28 meters², or from about 3 meters² to about 50 meters², or from about 12 meters² to about 80 meters².

In embodiments, the thrust pathway(s) 116 may increase the fluid flow rate between the fluid inlet area 117 and the fluid outlet area 118. As examples, a ratio of fluid flow rate at the inlet area to fluid flow rate at the outlet area may be from about 1 m/s to 2 m/s, or from about 2 m/s to 6 m/s, or from about 4 m/s to 10 m/s.

In embodiments, the thrust pathway 116 may advantageously facilitate a substantially continuous cycling of water, for example, with the turbine 114 driving the hydroelectric generator 108 and one or more thrust pathways to increase the velocity of the water passed across the turbine 114. One or more sensors may be located among the aforementioned components of the hydroelectric system 100, which may allow server 102 to receive data collected from the sensors and at least partially automatically adjust metrics, speeds, and/or other factors associated with the cycling of water throughout the hydroelectric system 100 and the overall operations of the hydroelectric system.

The thrust pathway aperture (i.e., fluid outlet area) will now be discussed in greater detail. FIG. 1B highlights an example of the thrust pathway aperture, which may also be shown in other figures.

According to embodiments, the thrust pathway aperture 118 may be configured to be larger than a turbine inlet aperture by which water is passed across the turbine 114, allowing one or more thrust pathways 116 to increase the velocity of the directed water while simultaneously directing the accelerated flow of water 120 through the thrust pathway 116.

In embodiments, a ratio of the thrust pathway aperture 118 area to the turbine inlet aperture area may be from about 12 meters² to 3 meters², or from about 28 meters² to about 3 meters², or from about 80 meters² to about 12 meters², without limitation.

According to embodiments, fluid may be additionally accelerated by the thrust pathway(s) via upstream thruster(s).

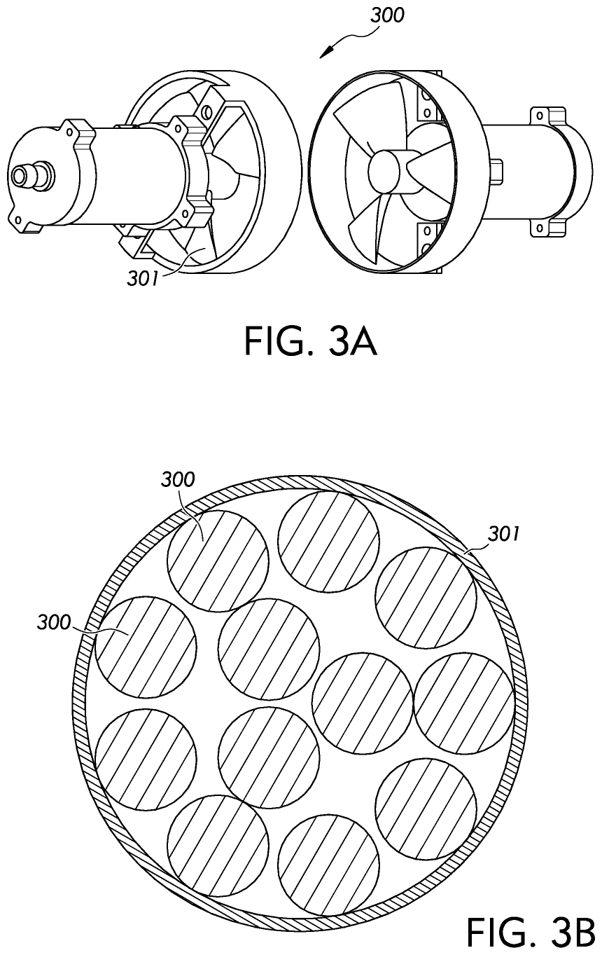

The thrusters will now be discussed in greater detail. FIGS. 1B and 3A-3B highlight an example of the thrusters, which may also be shown in other figures.

Referring now to FIG. 1B, according to embodiments, a thruster(s) 200 may be positioned directly or indirectly downstream, in terms of fluid flow, of the first fluid source and may also be positioned directly or indirectly upstream, in terms of fluid flow, of the thrust pathway(s). Accordingly, the thruster(s) may direct the water to the turbine 114 and throughout system 100. Further, the thruster(s) may increase the flow rate of fluid discharged from the first fluid source.

As examples, a ratio of fluid flow rate discharged from the first fluid source to fluid flow rate discharged from the thruster may be from about 2 m/s to 6 m/s. In other examples, a ratio of fluid flow rate entering the thruster to a fluid flow rate exiting the thruster may be from about 2 m/s to 8 m/s. In further examples, a ratio of fluid flow rate exiting the thruster to a fluid flow rate entering the thrust pathway may be from about 4 m/s to 10 m/s.

Still referring to FIG. 1B, in embodiments, one or more water thrusters 200 may be powered by an external power source 122, such as but not limited to, solar power, conventional hydro, natural gas, liquid natural gas, grid power, battery, wind power, and any other applicable power source that would be appreciated by those of skill in the art. It is to be understood that the water thrusters 200 may not only direct the flow of water circulating throughout the system 100, but also to increase the water velocity to flow accelerated water 120 to the turbine 114.

Referring now to FIG. 3A, an example set of water thrusters 300 having blades 301 is depicted. In one or more embodiments, a hydroelectrical system 100 may include one or more water thrusters 300 configured to be utilized to propel a fluid, for example water, in a substantially underwater setting. The rotating process of the applicable rotor blades may enable the Bernoulli Effect to occur, in which the pressure at the top of the rotor blades may be less than the pressure at the bottom of the rotor blades generating a lifting force and resulting in simultaneous increased fluid speed and decreased internal application. Thus, the thrusters 300 may be configured to operate in cooperation with one or more thrust pathways 116 to increase the pressure of water entering an aperture 118 from at least one reservoir 110, 112. In one example, the increase of water acceleration flow entering a conical shaped aperture 118 allows a lowering of fluid pressure in the respective regions associated with the accelerated flow.

Referring now to FIG. 3B, an array of thrusters 300 is depicted. In embodiments, a plurality of thrusters 300 are positioned within a circular frame 301. Each or some of the thrusters 300 may be the same or dissimilar to one another. Each of the thrusters may discharge a fluid flow into one or more thrust pathways.

The fluid or water flows (i.e., channels) will now be discussed in greater detail. FIG. 1B highlights an example of the fluid or water flows, which may also be shown in other figures.

In one or more embodiments, water and/or another fluid 120 may be accelerated to drive a turbine in the hydroelectrical generation system 100 at an optimal flow rate and velocity. The velocity of the water may be manipulated via thrusters and a thrust pathway, for example, as may be provided via a Bernoulli Effect. For example, water may enter a conical-shaped thrust pathway and exit having a higher velocity at the exit point. This operation may be assisted by the thruster, which may create a high volume of fluid rushing into the conical shape entrance of the thrust pathway. In this way, a system enabled by this disclosure may operate to simulate tidal force conditions in a controlled reservoir and move turbine blades to harvest the potential energy of the water and/or other fluid in the reservoir.

The hydroelectric generator will now be discussed in greater detail. FIG. 1B highlights an example of the hydroelectric generator, which may also be shown in other figures.

For purposes of this disclosure, the hydroelectric generator 108 may be a power source associated with the turbine 114, such as viewed in the configuration illustrated by the drawings. Those of skill in the art will appreciate that the illustrated configuration is one of many configurations of a hydroelectrical system that allows water to flow between the reservoirs 110, 112 in a dammed or undammed environment driving the hydroelectric generator 108 and turbine 114, and it is not intended to limit the scope of this disclosure in any way.

It is to be understood that the hydroelectric generator 108 may comprise rotors, which may include rotor blades, coils, and/or other generator components known to one of ordinary skill in the art. As will be appreciated by skilled artisans, a hydroelectrical generator 108 may be configured to be driven by a rotational force, which may be provided by turbines and/or blades moved by passing water and/or another fluid. The fluid force may be applied to one or more rotors associated with the hydroelectrical generator 108, which may activate the hydroelectrical generator 108. In one or more embodiments, the turbine 114 may provide the rotational force or any other applicable type of force to activate the hydroelectrical generator 108.

Still referring to FIG. 1B, output of the hydroelectric generator 108 may be facilitated by one or more supplemental power supplies associated with the hydroelectric generator 108, directly or indirectly, configured to increase the pressure of water and/or other fluids applied to the turbine 114. In embodiments, electricity outputted by the hydroelectric generator may go to a power grid and/or power storage 121.

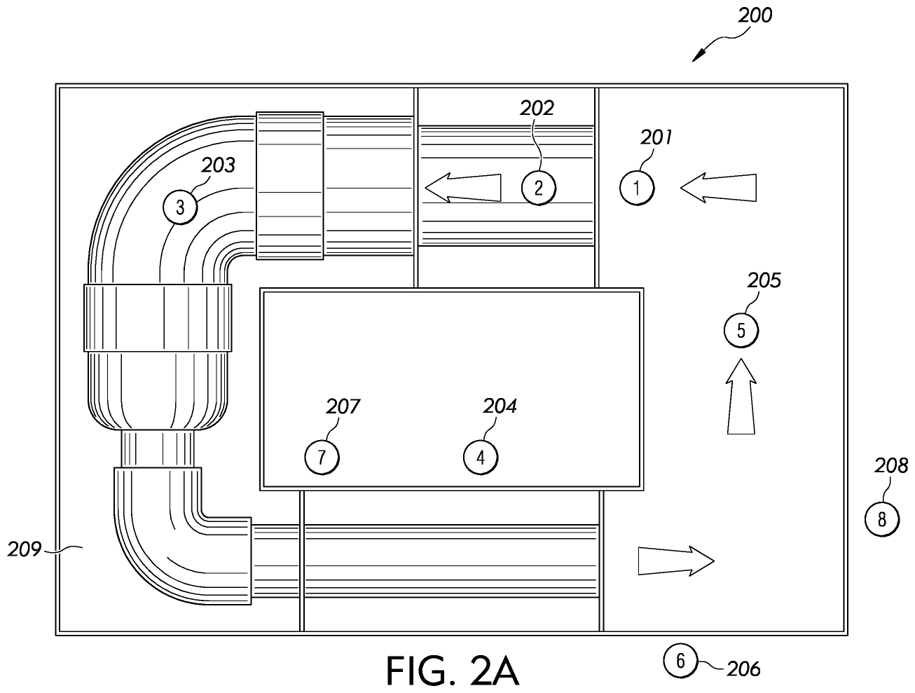

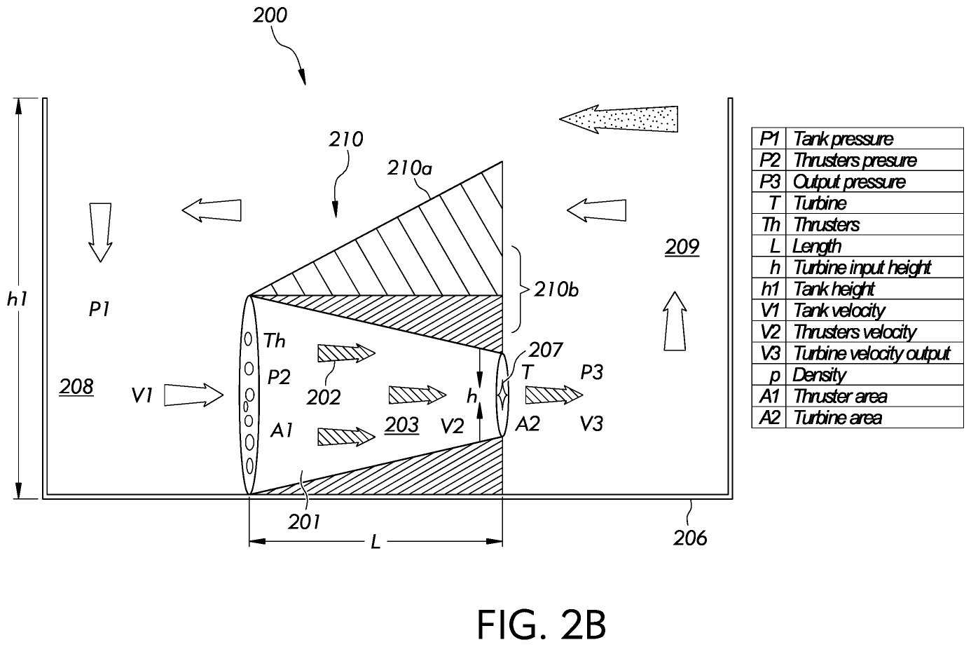

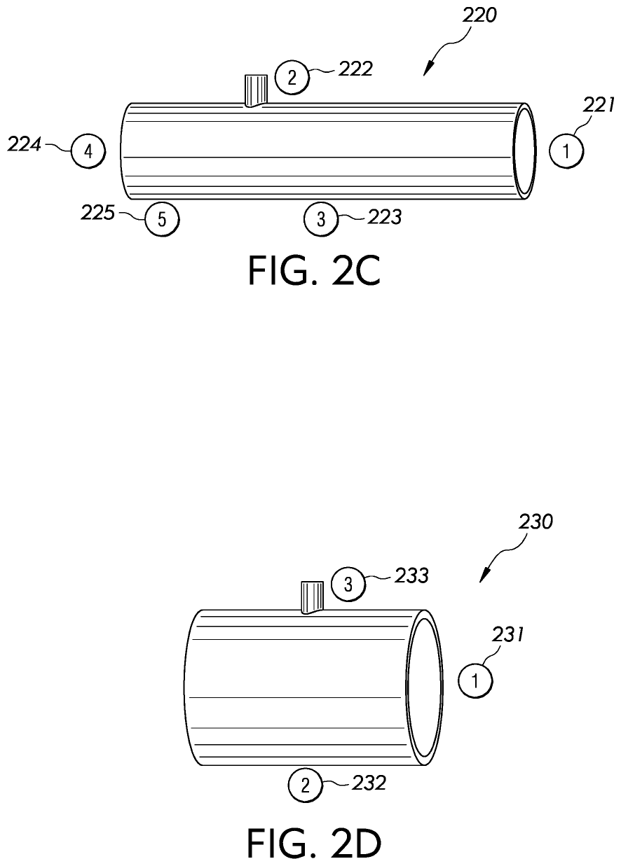

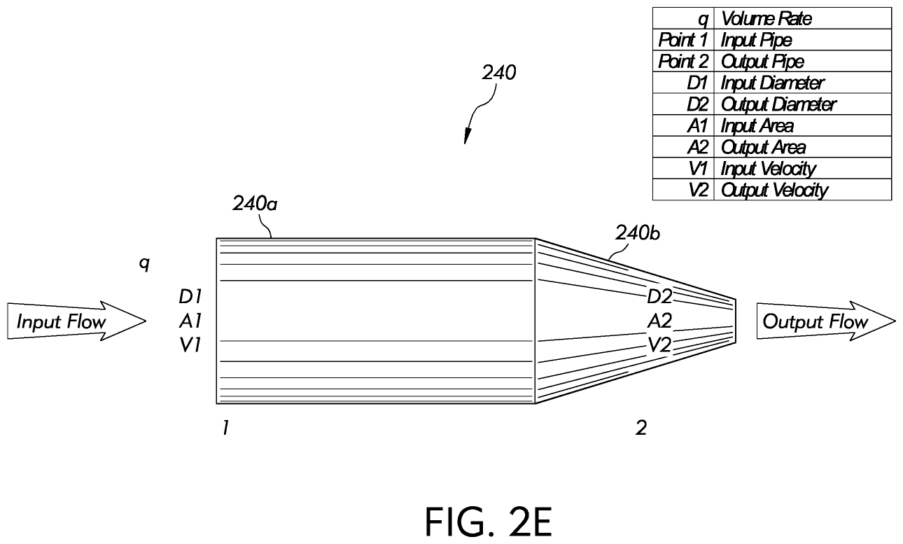

Referring now to FIG. 2A, another embodiment of a hydroelectrical power generation system 200 is schematically shown. In this exemplary embodiment, the system is in a closed loop path/communication configuration.

In the exemplary embodiment of FIG. 2A, the system 200 may be enclosed in a tank 206. From a first fluid reservoir 208, a thruster 201 provides a fluid flow 202 which moves along a fluid path 203 and into a second fluid reservoir 209. From the second fluid reservoir 209, fluid may continue to flow to a water turbine 207 wherein the fluid flow velocity 204 increases. The turbine 207 can drive a generator (not shown). From the turbine 207, the fluid flow may return along a return path 205 to and through the first reservoir 208, and then back to the thruster 201.

Referring now to FIG. 2B, another embodiment of a hydroelectrical power generation system 200 is schematically shown. In this exemplary embodiment, the system is in an open loop path/communication configuration.

In the exemplary embodiment of FIG. 2B, the system 200 may be in a partially open tank 206. A first fluid reservoir 208 may receive fluid from an open water source, such as an ocean. From the first fluid reservoir 208, a thruster 201 provides a fluid flow 202 which moves along a fluid path 203 and into a turbine 207. The turbine 207 can drive a generator (not shown). From the turbine 207, fluid may discharge into a second fluid reservoir 209. From the second fluid reservoir 209, fluid may return to the first reservoir 208 by passing over a transition interface 210.

In embodiments, the transition interface 201 may include an inclined surface 210a and/or an upstanding wall 210b. In some embodiments, the transition interface 201 can act as a separation between the first and second fluid reservoirs 208, 209. In other embodiments, the transition interface 201 can act as a fluid threshold. As a fluid threshold, the transition interface can hold back fluid flow from the second fluid reservoir 209 to the first fluid reservoir 208 until, for example, a volume of fluid in the second fluid reservoir reaches a threshold amount. In other examples, the fluid threshold may be based on a pressure differential between the first and second fluid reservoirs 208, 209.

Referring now to FIG. 2C, an exemplary high velocity chamber (HVC) 220 is depicted. In embodiments, and in lieu of a single turbine, the HVC 220 can be employed in open and closed loop path configurations of a hydroelectrical generation system, such as those shown in FIGS. 2A-2B.

According to embodiments, the HVC 220 can include a backflow gate 221 that can be used to close the HVC 220 for fluid filling. An air bubble vent 222 may release air trapped in the HVC 220. Multiple turbines 223 may be inside of the HVC 220. A flow output 224 can discharge fluid flow from the HVC 220. Sensor(s) 225 can monitor the HVC 220 for parameters such as fluid velocity, flow rate and pressure.

Referring now to FIG. 2D, a thruster chamber (TH) 230 is depicted. In embodiments, and in lieu of a single thruster, the TH 230 can be employed in open and closed loop path configurations of a hydroelectrical generation system, such as those shown in FIGS. 2A-2B.

The TH 230 may include multiple thrusters 231 to accommodate a wider range of fluid flow rates, tank size and/or turbine size. Sensor(s) 232 can monitor parameters such as fluid velocity, pressure, and temperature. An air vent 233 may release trapped air inside of the TH 230.

Referring now to FIG. 2E, a thrust pathway (TP) 240 is depicted. In embodiments, and in lieu of only a conical configuration, the TP 240 can be employed in open and closed loop path configurations of a hydroelectrical generation system, such as those shown in FIGS. 2A-2B.

The TP 240 may have a cylindrical portion 240a and a conical portion 240b. In embodiments, a ratio of an input diameter D1 of the cylindrical portion 240a to an output diameter D2 of the conical portion 240b may be from about 1 meter to 6 meters, or from about 2 meters to 10 meters, or another ratio of diameters that would be apparent to a skilled artisan that may correspond with a desired turbine size. In embodiments, a ratio of an input area A1 of the cylindrical portion 240 to an output area A2 of the conical portion 240b may be from about 0.5 meters² to about 30 meters², or from about 3 meters² to about 80 meters², or from about 10 meters² to about 50 meters². In embodiments, a ratio of an input velocity V1 of the cylindrical portion 240 to an output velocity V2 of the conical portion 240b may be from about 2 m/s to 6 m/s, or from about 2 m/s to 8 m/s, from about 4 m/s to 10 m/s, or another ratio that would be appreciated by skilled artisans that may correspond with a desired turbine size.

During operation or a method according to the present invention, a system enabled by this disclosure may advantageously convert the energy provided by the flowing fluid into substantially clean power, via a low-risk and environmentally friendly method.

In one or more embodiments, the method may begin from the first reservoir 110. In a step, water (or other fluid) stored in the reservoir 110 may be received by one or more thrusters 200 and, in another step, accelerated through one or more thrust pathways 116. This motion of water may allow the resulting accelerated water 120, in a step, to be passed through one or more impellers causing the turbine 114 to rotate and, in another step, drive the hydroelectric generator 108.

Once the accelerated water 120 is passed across the turbine 114, the accelerated water may, in a step, compile in a second reservoir 112 and passively or actively release, in a step, the accelerated water, via a return 123, into the first reservoir 110 allowing a continuous cycling of the water to occur. In one or more embodiments, the aforementioned steps of water transition may also be accomplished by the reservoir transition interface. An example of a reservoir transition interface may include a sloped plane having a lower edge adjacent to a first reservoir and a higher edge adjacent to a second reservoir such that water may flow over the higher edge from an output reservoir, across the sloped plane, and past the lower edge in an input reservoir.

The functions of the thrusters 200 may be performed while the flow of accelerated water 120 is substantially simultaneously directed to one or more thrust pathways 116. For example, the circumference of one or more thrust pathways 116 may gradually decrease as the water flows through the thrust pathway resulting in acceleration of the flowing water 120 being generated and/or sustained subject to the configuration. For example, one or more thrusters may facilitate the velocity of water flowing passing across the turbine 114 along with one or more thrust pathways 116 resulting in the thrusters 200 defining a desired flow rate associated with accelerated flow of water 120. Additionally, thrusters 200 may cause a pressure differential between a first reservoir 110 and second reservoir 112, resulting in the water level of the second reservoir 112 being higher than the first reservoir 110.

In one or more embodiments, the desired flow rate may be determined by a server 102 or the user operating on a computing device via the applicable user interface associated with a system 100, for example, based on the data collected by the one or more sensors. The reservoir transition interface may be configured to provide a platform for the server 102 or the user to control the velocity and direction of water circulating through the system 100 in the manner with increased efficiency for operation of the system 100. For example, the reservoir transition interface may be located between reservoirs 110, 112 and configured to direct water from the second reservoir 112 to the first reservoir 110 via the control structure 123 such as, an inclined and/or sloped surface, one-way flow valve, check valve, weir, or any other applicable hydrological control structure. In at least one embodiment in which power generating from the aforementioned cycle is not desired to be output to one or more power grids associated with the system 100, the power may be configured to be stored and accessed from an internal or external storage component 121, such as a battery or any other applicable power storage medium wherein the internal or external storage component may be discharged onto water thrusters 200 in order to power the cycle.

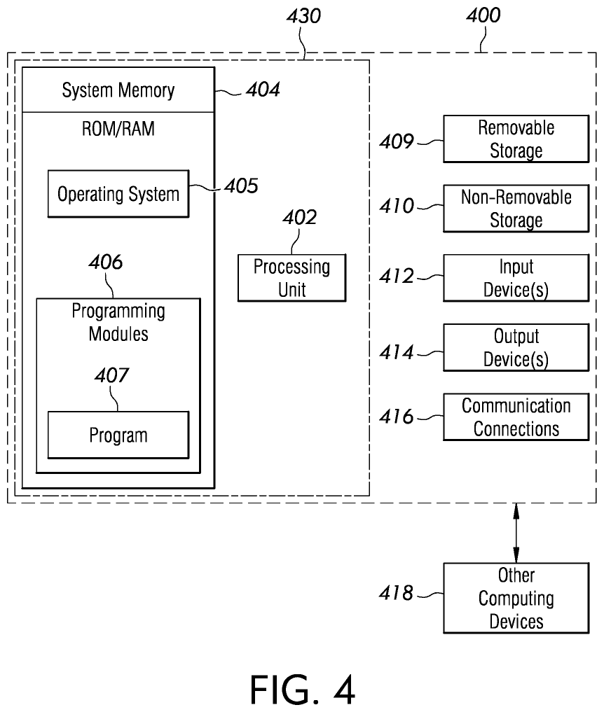

Referring now to FIG. 4, an illustrative computerized device will be discussed, without limitation. Various aspects and functions described in accord with the present disclosure may be implemented as hardware or software on one or more illustrative computerized devices 400 or other computerized devices. There are many examples of illustrative computerized devices 400 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 400 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 400, among others. Additionally, aspects in accord with the present disclosure may be located on a single illustrative computerized device 400 or may be distributed among one or more illustrative computerized devices 400 connected to one or more communication networks.

For example, various aspects and functions may be distributed among one or more illustrative computerized devices 400 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 4 is a block diagram of a system including an example computing device 400 and other computing devices. Consistent with the embodiments described herein, the aforementioned actions performed by the system 100 may be implemented in a computing device, such as the computing device 104 (FIG. 1A). Any suitable combination of hardware, software, or firmware may be used to implement the computing device 104.

The aforementioned system, device, and processors are examples and other systems, devices, and processors may be included by the aforementioned computing device. Furthermore, the computing device 104 may comprise an operating environment for the system 100. Processes and data related to the system 100 may operate in other environments and are not limited to the computing device 104.

A system consistent with an embodiment of the invention may include one or more computing devices, such as the computing device 400 of FIG. 4. In a basic configuration, a computing device 400 may include at least one processing unit 402 and system memory 404. Depending on the configuration and type of computing device, system memory 404 may comprise, but is not limited to, volatile (e.g., random-access memory (RAM)), non-volatile (e.g., read-only memory (ROM)), flash memory, or other combination or memory. System memory 404 may include an operating system 405, and one or more programming modules 406. An operating system 405, for example, may be suitable for controlling the computing device's operation. In one embodiment, programming modules 406 may include, for example, a program module 407 for executing the actions of a system 100. Furthermore, embodiments of the invention may be practiced in conjunction with a graphics library, other operating systems, or any other application program and is not limited to any particular application or system. This basic configuration is illustrated in FIG. 4 by those components within a dashed line 430.

Computing devices 400 may have additional features or functionality. For example, computing devices 400 may also include additional data storage devices (removable and/or non-removable) such as, for example, magnetic disks, optical disks, or tape. Such additional storage is illustrated in FIG. 4 by a removable storage 409 and a non-removable storage 410.

Computer storage media may include volatile and nonvolatile, removable, and non-removable media implemented in any method or technology for storage of information, such as computer readable instructions, data structures, program modules, or other data. System memory 404, removable storage 409, and non-removable storage 410 are computer storage media examples (i.e., memory storage) and provided without limitation. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device 400. Any such computer storage media may be part of a system 400.

Computing devices 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

An illustrative computing device 400 may also contain a communication connection 416 that may allow a system 100 to communicate with other computing devices 418, such as over a network in a distributed computing environment, for example, an intranet or the Internet. A communication connection 416 is one example of communication media. Communication media may typically be embodied by computer readable instructions, data structures, program modules, or other data in a modulated data signal, such as a carrier wave or other transport mechanism, and may include any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including an operating system 405. While executing on a processing unit 402, programming modules 406 (e.g., program module 407) may perform processes including, for example, one or more of the stages of a process. The aforementioned processes are examples, and the processing unit 402 may perform other processes.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments enabled by this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of a computerized device on which aspects of the invention may be operated are described above, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

In operation, a hydroelectrical power system may be used to assist with generation of electrical power from a hydroelectrical source. In this illustrative operation, a method of generating electrical power may benefit from aspects of the example hydroelectrical power system discussed throughout this disclosure. The hydroelectrical power system may include a primary power source and at least one turbine. In one example of the method, the turbine may drive the primary power source. The method may include directing water to the turbine via a thruster about a thrust pathway. The thrust pathway may increase the velocity of the water and/or other fluid interfacing with the power generation components, for example, the generator.

In one or more examples of the method, a thrust pathway may receive water from a receiving aperture. The method may additionally include accelerating the flow of the water and/or other fluid via the thrust pathway by decreasing an interior diameter of the thrust pathway as the axial position transitions from a receiving end of the thrust pathway to an output end of the thrust pathway. For example, the method may include accelerating the water and/or other fluid via a thrust pathway that is at least partially conical.

In one or more embodiments of the method, the thruster may receive water and/or another fluid from a first reservoir and eject the water and/or other fluid into a second reservoir. The water from the first reservoir may be at least partially replaced by the water from the second reservoir via a reservoir transition interface.

Skilled artisans will appreciate additional methods within the scope and spirit of the disclosure for performing the operations provided by the examples below after having the benefit of this disclosure. Such additional methods are intended to be included by this disclosure.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

1. A hydroelectrical power generation system comprising:
a liquid source to provide a liquid;
a thruster configured to:
receive power from an external power source;
receive the liquid at a first flow rate from a first liquid source;
increase the first flow rate to a second flow rate;
a thrust pathway that increases the second flow rate to a third flow rate;
a turbine that receives the liquid at about the third flow rate from the thrust pathway; and
a generator that is driven by the turbine;
wherein at least part of the liquid that passes the turbine is recycled through a return path and received by the thrust pathway in an at least partial loop.

2. The system of claim 1, wherein the first liquid source is one of a naturally flowing water source and a man-made flowing water source.

3. The system of claim 1, wherein the thruster includes a plurality of blades.

4. The system of claim 1, further including a plurality of thrusters upstream, in terms of liquid flow, of the thrust pathway.

5. (canceled)

6. The system of claim 1, wherein the thrust pathway is at least partially conical in shape.

7. The system of claim 1, wherein the generator is configured to connect to a power storage/grid.

8-20. (canceled)

21. The system of claim 1, wherein the thrust pathway further comprises:
an input pipe operatively attached to a cylindrical portion located at a receiving end of the thrust pathway having an input diameter; and
an output pipe operatively attached to the conical portion located at an output end of the thrust pathway having an output diameter, the output end being distal to the receiving end.

22. The system of claim 21:
wherein the output diameter is no more than 60% of the input diameter.

23. The system of claim 21:
wherein an output area provided by the output pipe rate is no more than 20% of an input area provided by the input pipe.

24. The system of claim 21:
wherein the liquid is received by the input pipe at the second flow rate; and
wherein the liquid passes through the output pipe at about the third flow rate.

25. The system of claim 24:
wherein the third flow rate is at least 25% greater than the second flow rate.

26. The system of claim 1, further comprising an air bubble vent operatively connected to the thrust pathway to vent a gas.

27. The system of claim 1, wherein the liquid source is a combination of an open liquid source and the closed liquid source.

28. The system of claim 1, wherein the external power source is selectively supplemented by the generator to provide the power.

29. The system of claim 1, wherein the external power source is renewably generated.
